(19) United States
(12) Patent Application Publication
(10) Pub. No.: US 2024/0043624 A1
(43) Pub. Date: Feb. 8, 2024

(54) CHAIN-EXTENDED SILICONES, METHOD OF MAKING, CURABLE COMPOSITION INCLUDING THE SAME, AND THERMAL GAP FILLER

(71) Applicant: 3M INNOVATIVE PROPERTIES COMPANY, St. Paul, MN (US)

(72) Inventors: Jens Eichler, Kaarst (DE); Ricardo Mzoguchi Gorgoll, Kanagawa (JP); Peter Bissinger, Diessen (DE); Simone Jurjevic, Neuss (DE); Wolf Steiger, Weil-Petzenhausen (DE); Patricia J. Tegeder, Duesseldorf (DE)

(21) Appl. No.: 18/554,485

(22) PCT Filed: Mar. 4, 2022
(86) PCT No.: PCT/IB2022/051946

§ 371 Date: Oct. 9, 2023

Related U.S. Application Data
(60) Provisional application No. 63/174,136, filed on Apr. 13, 2021.

(51) Int. Cl. C08G 77/388; C08G 77/26

(52) U.S. Cl. CPC C08G 77/388; C08G 77/26; C08G 2330/00

(57) ABSTRACT

A chain-extended silicone represented by the formula Each R¹ independently represents H or a C₁-C₁₅ hydrocarbyl group. Each R² independently represents H or a C₁-C₆ alkyl group. Each A independently represents a C₁-C₁₈ hydrocarbylene group, optionally substituted with up to 5 heteroatoms selected from the group consisting of O, N and S. Each Z independently represents a leaving group displaceable by a primary or secondary alkylamine. Each m independently represents an integer from 5 to 1000, inclusive. n represents an integer greater than or equal to two. The chain-extended silicone can be functionalized with aziridine groups. Methods of making the foregoing are also disclosed. Curable compositions, including a thermal gap filler, including the chain-extended silicone are also disclosed.

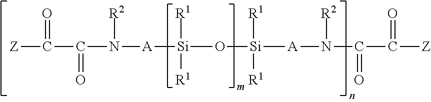

### TECHNICAL FIELD

The present disclosure broadly relates to chain-extended silicones, curable compositions containing them, methods of making them and their application as a thermal gap filler.

### BACKGROUND

Thermal interface materials (TIMs) are placed at the interfaces between heat sources and heat sinks to reduce the thermal resistance of those interfaces. Examples of heat sources are electric vehicle batteries during charging and discharging, electronic components such as integrated circuits (ICs) and IC packages, and electromechanical devices such as electric machines (e.g., motors). The effectiveness of such TIMs depends on their thermal conductivity, as well as intimate and conformal contact with the surfaces of the source and sink. To achieve conformal contact, TIMs typically include a polymeric component. To achieve high thermal conductivity, TIMs typically include an inorganic component. Hence, common TIMs are inorganic particle filled polymer matrix composites.

TIMs that can be used to fill spaces between components of a device to enhance thermal transfer between them are commonly known as thermally-conductive gap fillers (or simply thermal gap fillers).

### SUMMARY

The present disclosure provides new silicone-based compounds and compositions that are useful for manufacture of materials suitable as thermal gap fillers. The thermal gap fillers according to the present disclosure may have a Shore A Hardness of 70 or less (e.g., 60 to 70) while achieving a thermal conductivity as high as 3 W/m·K. Additionally, good elasticity and fire-resistance are also achievable.

In one aspect, the present disclosure provides a chain-extended silicone represented by the formula

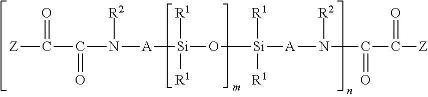

wherein:
each R¹ independently represents H or a C₁-C₁₅ hydrocarbyl group;
each R² independently represents H or a C₁-C₆ alkyl group;
each A independently represents a C₁-C₁₈ hydrocarbylene group, optionally substituted with up to 5 heteroatoms selected from the group consisting of O, N and S;
each Z independently represents a leaving group displaceable by a primary or secondary alkylamine;
each m independently represents an integer from 5 to 1000, inclusive; and
each n represents an integer greater than or equal to two.

In another aspect, the present disclosure provides a method comprising:
a) providing a represented by the formula

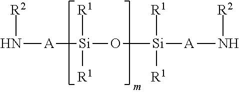

wherein:
each R¹ independently represents H or a C₁-C₁₅ hydrocarbyl group;
each R² independently represents H or a C₁-C₆ alkyl group; and
each A independently represents a C₁-C₁₈ hydrocarbylene group, optionally substituted with up to 5 heteroatoms selected from the group consisting of O, N and S; and
b) reacting the silicone with an oxalic acid derivative represented by the formula

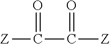

wherein each Z independently represents a leaving group that is displaceable by an amine group on the silicone, thereby providing a chain-extended silicone represented by the formula

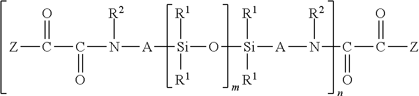

wherein:
each m independently represents an integer from 5 to 1000, inclusive; and
each n represents an integer greater than or equal to two.

In some embodiments, the method further comprises:
c) reacting the chain-extended silicone with at least one aminoalkylaziridine represented by the formula

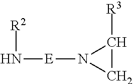

wherein
each R³ represents H or a C₁-C₆ hydrocarbyl group; and
each E independently represents a C₁-C₁₈ hydrocarbylene group, optionally substituted with up to 5 heteroatoms selected from the group consisting of O, N and S.

In yet another aspect, the present disclosure provides a chain-extended silicone polyaziridine represented by the formula

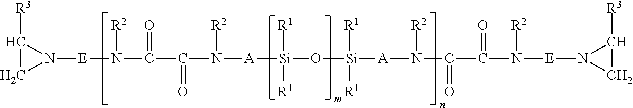

wherein:
each R¹ independently represents H or a C₁-C₁₅ hydrocarbyl group;
each R² independently represents H or a C₁-C₆ alkyl group;
each R³ independently represents H or a C₁-C₆ hydrocarbyl group;
each A independently represents a C₁-C₁₈ hydrocarbylene group, optionally substituted with up to 5 heteroatoms selected from the group consisting of O, N and S;
each E independently represents a C₁-C₁₈ hydrocarbylene group, optionally substituted with up to 5 heteroatoms selected from the group consisting of O, N and S;
each m independently represents an integer from 5 to 1000, inclusive; and
n represents an integer greater than or equal to two.

In another aspect, the present disclosure provides a curable composition comprising a chain-extended silicone polyaziridine according to the present disclosure, and a curative for the chain-extended silicone polyaziridine.

In yet another aspect, the present disclosure provides a thermal gap filler comprising an at least partially cured reaction product of a curable composition according to the present disclosure, wherein the thermal gap filler is flowable at 25° C.

As used herein, whenever not specifically given, units of molecular weight referred to herein are grams/mole.

Features and advantages of the present disclosure will be further understood upon consideration of the detailed description as well as the appended claims.

### DETAILED DESCRIPTION

Compounds used in the present disclosure can be synthesized starting from a chain-extended silicone represented by the formula

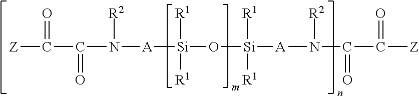

Each R² independently represents H or a C₁-C₆ alkyl group (e.g., a C₁-C₄ alkyl group). Examples include methyl, ethyl, propyl, isopropyl, butyl, pentyl, hexyl, and cyclohexyl. Of these, methyl is often preferred.

Each A independently represents a C₁-C₈ hydrocarbylene group (e.g., a C₁-C₁₂ hydrocarbylene group, a C₁-C₈ hydrocarbylene group, a C₁-C₆ hydrocarbylene group, or a C₁-C₄ alkylene group), optionally substituted with up to 5 heteroatoms selected from the group consisting of O, N, and S, preferably positioned to avoid O—N, N—N, and S—N bonds. Examples include methylene, ethylene, propylene, butylene, isobutylene, hexylene, octylene, phenylene, decylene, dodecylene, hexadecylene, octadecylene, —CH₂CH₂OCH₂CH₂—, —CH₂CH(CH₃)OCH₂CH(CH₃)—, and —CH₂CH₂OCH₂CH₂OCH₂CH₂—.

Each Z independently represents a leaving group displaceable by a primary or secondary alkylamine. Suitable leaving groups will be well-known to those of ordinary skill in the art and may include, for example, halide (e.g., F, Cl, Br, I), alkoxy groups (e.g., C₁-C₆ alkoxy groups such as methoxy, ethoxy, propoxy, butoxy, pentoxy, hexoxy, or cyclohexoxy), and carboxylates (e.g., acetate, benzoate). In some preferred embodiments, at least one Z is a C₁-C₆ alkoxy group.

Each m independently represents an integer from 5 to 1000, inclusive. In some embodiments, m independently represents an integer from 5 to 100, an integer from 5 to 50, an integer from 5 to 25, or an integer from 5 to 10.

n Represents an integer greater than or equal to two; for example, greater than 2, greater than 3, greater than 4, greater than 5, or even greater to 10.

The chain-extended silicones can be made, for example, by reaction of a corresponding diaminosilicone represented by the formula:

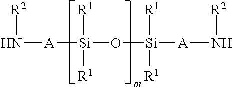

with an oxalic acid derivative represented by the formula

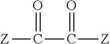

wherein R¹, R², A, and Z are as previously defined.

Suitable amine-terminated silicones and oxalic acid derivatives can be obtained commercially or prepared generally according to known methods. For example, bis(aminopropyl)-terminated polydimethylsiloxanes are available from Sigma-Aldrich, Saint Louis, Missouri, as product nos. 481688 (Mₙ˜2,500), 481696 (Mₙ˜27,000), and from Gelest, Inc. as DMS-A11. They can also be made, for example, according to the procedures in U.S. Pat. No. 8,653,218 B2 (Soucek et al.), or as described by Ekin and Webster in Journal of Polymer Science: Part A: Polymer Chemistry, 2006, 44, pp. 4880-4894, the disclosures of which are incorporated herein by reference.

Useful chain-extended silicones as described above can also be obtained commercially and/or prepared generally according to known methods such as, for example, as described in U.S. Pat. No. 8,765,881 B2 (Hays et al.), the disclosure of which is incorporated herein by reference.

The chain-extended silicones described above may be further reacted with at least one aminoalkylaziridine represented by the formula

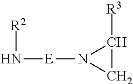

Each R³ independently represents H or a C₁-C₆ hydrocarbyl group (e.g., methyl, ethyl, propyl, isopropyl, butyl, isobutyl, pentyl, hexyl, cyclohexyl, or phenyl). In some embodiments, each R³ independently represents a C₁-C₄ alkyl group (e.g., methyl, ethyl, propyl, isopropyl, butyl, or isobutyl).

Each E independently represents a C₁-C₁₈ hydrocarbylene group (e.g., a C₁-C₁₂ hydrocarbylene group, a C₁-C₈ hydrocarbylene group, a C₁-C₆ hydrocarbylene group, or a C₁-C₄ alkylene group), optionally substituted with up to 5 heteroatoms selected from the group consisting of O, N, and S, preferably positioned to avoid O—N, N—N, and S—N bonds. Examples include methylene, ethylene, propylene, butylene, isobutylene, hexylene, octylene, phenylene, decylene, dodecylene, hexadecylene, octadecylene, —CH₂CH₂OCH₂CH₂—, —CH₂CH(CH₃)OCH₂CH(CH₃)—, and —CH₂CH₂OCH₂CH₂OCH₂CH₂—.

The resulting product of the above-described reaction is a chain-extended silicone polyaziridine represented by the formula

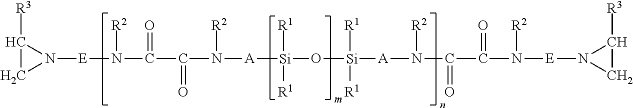

wherein R¹, R², R³, A, E, m, and n are as previously defined.

Chain-extended silicone polyaziridines according to the present disclosure are polymerizable, for example, using a curative such as a Lewis acid catalyst (e.g., a zinc²⁺ salt such as, for example, Zn(CF₃SO₃)₂), or a Bronsted acid (e.g., p-toluenesulfonic acid or benzoic acid), or a polyfunctional primary and/or secondary amine (e.g., having at least two, three, or four primary and/or secondary amino groups). Additional curatives for polyaziridines are known in the art, and selection of a specific curative or combination of curatives is within the capabilities of those having ordinary skill in the art.

Accordingly, the present disclosure also provides a curable composition comprising a chain-extended silicone polyaziridine according to the present disclosure and a curative for the chain-extended silicone polyaziridine.

Often an electrically-insulating thermal filler is included in the curable composition. Examples of suitable electrically insulating, thermally conductive fillers include ceramics such as oxides, hydrates, silicates, borides, carbides, and nitrides. Suitable oxides include, e.g., silicon oxide, aluminum oxide (e.g., alpha alumina), and zinc oxide. Suitable nitrides include, e.g., boron nitride, silicon nitride, and aluminum nitride. Suitable carbides include, e.g., silicon carbide. Other thermally conducting fillers include graphite and metals such as aluminum and copper. Mixtures of thermally conductive fillers can also be used. Through-plane thermal conductivity is most critical in this application. Therefore, in some embodiments, generally symmetrical (e.g., spherical fillers) may be preferred, as asymmetrical fibers, flakes, or plates may be substantially aligned in the in-plane or through plane direction. As used herein , the term “thermal filler” refers to filler particles having a thermal conductivity of at least 0.5 W/m·K, preferably at least 1 W/m·K, more preferably at least 1.5 W/m·K, more preferably at least 2 W/m·K, and more preferably at least 5 W/m·K.

Fillers and other additives, if present in the curable composition, are preferably non-interfering in the sense that they do not interfere substantially with curing of the curable composition.

In some embodiments, the curable composition includes at least 30 percent, at least 40 percent, at least 50 percent, at least 60 percent, at least 70 percent, or even at least 80 percent by volume of a thermal filler, and may be suitable for use as a thermal gap filler as described above, for example, for inclusion within a battery module.

To aid in dispersion and increase filler loading, in some embodiments, the thermally conductive fillers may be surface-treated or coated. Generally, any known surface treatments and coatings may be suitable.

The selection of the polymer used to form the thermally-conducting gap filler plays a critical role in achieving the desired end-use performance requirements. For example, the polymer often plays a major role in controlling one or more of: the rheological behavior of the uncured layer; the temperature of cure (e.g., curing at room temperature); time to cure profile of the gap filler (open time and cure time); the stability of the cured product (both temperature stability and chemical resistance); the softness and spring back (recovery on deformation) to ensure good contact under use conditions; the wetting behavior on the base plate and battery components; the absence of contaminants (e g , unreacted materials, low molecular weight materials) or volatile components; and the absence of air inclusions and gas or bubble formation.

For example, in car battery applications, the gap filler may need to provide stability in the range of −40° C. to 85° C. The gap filler may further need to provide the desired deformation and recovery (e.g., low hardness) needed to withstand charging and discharging processes, as well as travel over varying road conditions. In some embodiments, a Shore A hardness of no greater than 80, e.g., no greater than 70, or even no greater than 50 may be desired. Also, as repair and replacement may be important, in some embodiments, the polymer should permit subsequent cure and bonding of additional layers, e.g., multiple layers of the same thermally-conducting gap filler.

Objects and advantages of this disclosure are further illustrated by the following non—limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

### Example 1

### (Amine:Diethyl Oxalate=5:1)

In a round-bottom flask, 50 g of a,w-bis[3-aminopropyl]-poly-dimethylsiloxane (Wacker Fluid NH130D, Wacker Chemie AG, Munich, Germany; 11042 g/mol, 4.53 mmol) were added to with 6.62 g (45.3 mmol, 5 equiv. (with regard to amine) of diethyl oxalate, MilliporeSigma, Saint Louis, Missouri) and stirred vigorously at 55° C. for 3 hr. After that time, the reaction mixture was cooled to room temperature and stirred for 16 hr. ¹H NMR spectroscopy indicated that complete conversion occurred by disappearance of the resonance at 2.7 ppm. All volatiles were removed at reduced pressure (100 Pa) in a rotary evaporator at 50° C. for a sufficient period of time, resulting in 50.4 g (99% theoretical yield) of a clear colorless slightly viscous product.

### Example 2

a,w-Bis[3-ethyloxamidopropyl]-poly-dimethylsiloxane (49.2 g from Example 1; 11242 g/mol; 4.38 mmol) was stirred in a round bottom flask at 55° C. 3-(Aziridin-1-yl)-butan-1-amine, 1.02 g of , 8.93 mmol, 2% excess, available according to procedures in German Pat. No. 1745810 (Jochum et al.) or from Aston Chemical, Cornelius, North Carolina) for 3 hr. ¹H NMR spectroscopy indicated that complete conversion occurred by disappearance of the resonance at 4.32 ppm. All volatiles were removed at reduced pressure (100 Pa) using a rotary evaporator at 50° C. for a sufficient period of time, 49.6 g (100% of theory) of a whitish, turbid, viscous product remained, aziridine equivalent weight=7467 g/equiv.

### Example 3

### (Amine:Diethyl Oxalate=2.5:1)

In a round-bottom flask, 50 g of a,w-bis[3-aminopropyl]-poly-dimethylsiloxane (Wacker Fluid NH130D; 11042 g/mol, 4.53 mmol) were added to 3.31 g (22.6 mmol, 2.5 equiv. (with regard to amine) of diethyl oxalate) and stirred vigorously at 55° C. for 3 hr. After that time, the reaction mixture was cooled to room temperature and stirred for 16 hr. ¹H NMR spectroscopy indicated that complete conversion occurred by disappearance of the resonance at 2.7 ppm. All volatiles were removed at reduced pressure (100 Pa) using a rotary evaporator at 50° C. for a sufficient period of time resulting in 50.8 g (100% of theory) of a clear colorless slightly viscous product.

### Example 4

a,w-Bis[3-ethyloxamidopropyl]-poly-dimethylsiloxane (50 g from Example 3, 11378 g/mol, 4.39 mmol) was stirred in a round-bottom flask at 55° C. 3-(Aziridin-1-yl)-butan-1-amine, 1.04 g, 8.93 mmol, 2% excess) for 3 hr. ¹H NMR spectroscopy indicated that complete conversion occurred by disappearance of the resonance at 4.32 ppm. All volatiles were removed at reduced pressure (100 Pa) using a rotary evaporator at 50° C. for a sufficient period of time, resulting in 49.7 g (98% of theory) of a whitish, turbid, viscous product, aziridine equivalent weight=7287 g/equiv.

### Example 5

### (Amine:Diethyl Oxalate=1.5:1)

In a round-bottom flask, 50 g of a,w-bis[3-aminopropyl]-poly-dimethylsiloxane (Wacker Fluid NH130D; 11042 g/mol, 4.53 mmol) were added to 1.99 g (13.6 mmol, 1.5 equiv. (with regard to amine) of diethyl oxalate) and stirred vigorously at 55° C. for 3 hr. After that time, the reaction mixture was cooled to room temperature and stirred for 16 hr. ¹H NMR spectroscopy indicated that complete conversion occurred by disappearance of the resonance at 2.7 ppm. All volatiles were removed in vacuum (100 Pa) in a rotary evaporator at 50° C. for a sufficient period of time, resulting in 50.4 g (99% of theory) of a clear colorless slightly viscous product.

### Example 6

a,w-Bis[3-ethyloxamidopropyl]-poly-dimethylsiloxane (48.5 g from Example 5, 11378 g/mol, 4.26 mmol) were stirred in a round-bottom flask at 55° C. 3-(Aziridin-1-yl)-butan-1-amine, 1.0 g, 8.76 mmol, 2% excess) for 3 hr. ¹H NMR spectroscopy indicated that complete conversion occurred by disappearance of the resonance at 4.32 ppm. All volatiles were removed at reduced pressure (100 Pa) using a rotary evaporator at 50° C. for a sufficient period of time resulting in 48.6 g (99% of theory) of a whitish, turbid, viscous product, aziridine equivalent weight=8066 g/equiv.

### Example 7

### (Amine:Diethyl Oxalate=1:1)

In a round-bottom flask, 50 g of a,w-bis[3-aminopropyl]-poly-dimethylsiloxane (Wacker Fluid NH130D; 11042 g/mol, 4.53 mmol) were added to 1.33 g (9.06 mmol, 1 equiv. (with regard to amine) diethyl oxalate) and stirred vigorously at 55° C. for 3 hr. After that time, the reaction mixture was cooled to room temperature and stirred for 16 hr. ¹H NMR spectroscopy indicated that complete conversion occurred by disappearance of the resonance at 2.7 ppm. All volatiles were removed at reduced pressure (100 Pa) using a rotary evaporator at 50° C. for a sufficient period of time, resulting in 50.5 g (99% of theory) of a clear colorless slightly viscous product.

### Example 8

a,w-Bis[3-ethyloxamidopropyl]-poly-dimethylsiloxane (48.5 g from Example 5, 11378 g/mol; 4.26 mmol) were stirred in a round-bottom flask at 55° C. 3-(Aziridin-1-yl)-butan-1-amine, 1.0 g, 8.76 mmol, 2% excess) for 3 hr. 1 H NMR spectroscopy indicated that complete conversion occurred by disappearance of the resonance at 4.32 ppm. All volatiles are removed at reduced pressure (100 Pa) using a rotary evaporator at 50° C. for a sufficient period of time resulting in 49.3 g (99% of theory) of a whitish, turbid, viscous product, aziridino equivalent weight=12093 g/equiv.

Any cited references, patents, and patent applications in this application that are incorporated by reference, are incorporated in a consistent manner. In the event of inconsistencies or contradictions between portions of the incorporated references and this application, the information in this application shall control. The preceding description, given in order to enable one of ordinary skill in the art to practice the claimed disclosure, is not to be construed as limiting the scope of the disclosure, which is defined by the claims and all equivalents thereto.

1. A chain-extended silicone represented by the formula 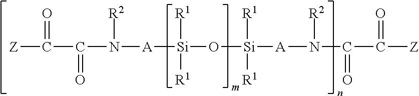
wherein:
each R¹ independently represents H or a C₁-C₁₅ hydrocarbyl group;
each R² independently represents H or a C₁-C₆ alkyl group;
each A independently represents a C₁-C₁₈ hydrocarbylene group, optionally substituted with up to 5 heteroatoms selected from the group consisting of O, N and S;
each Z independently represents a leaving group displaceable by a primary or secondary alkylamine;
each m independently represents an integer from 5 to 1000, inclusive; and
n represents an integer greater than or equal to two.

2. A method comprising:
a) providing a represented by the formula 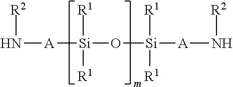
wherein:
each R¹ independently represents H or a C₁-C₁₅ hydrocarbyl group;
each R² independently represents H or a C₁-C₆ alkyl group; and
each A independently represents a C₁-C₁₈ hydrocarbylene group, optionally substituted with up to 5 heteroatoms selected from the group consisting of O, N and S; and
b) reacting the silicone with an oxalic acid derivative represented by the formula 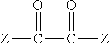
wherein each Z independently represents a leaving group that is displaceable by an amine group on the silicone, thereby providing a chain-extended silicone represented by the formula 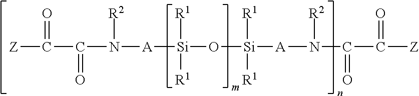
wherein:
each m independently represents an integer from 5 to 1000, inclusive; and
n represents an integer greater than or equal to two.

3. The method of claim 2, wherein Z represents a C₁-C₆ alkoxy group.

4. The method of claim 2, further comprising:
c) reacting the chain-extended silicone with at least one aminoalkylaziridine represented by the formula 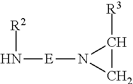
wherein
each R³ represents H or a C₁-C₆ hydrocarbyl group; and
each E independently represents a C₁-C₁₈ hydrocarbylene group, optionally substituted with up to 5 heteroatoms selected from the group consisting of O, N and S.

5. A chain-extended silicone polyaziridine represented by the formula 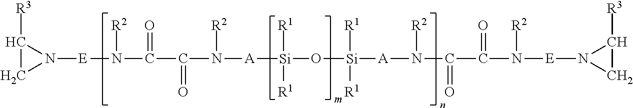
wherein:
each R¹ independently represents H or a C₁-C₁₅ hydrocarbyl group;
each R² independently represents H or a C₁-C₆ alkyl group;
each R³ independently represents H or a C₁-C₆ hydrocarbyl group;
each A independently represents a C₁-C₁₈ hydrocarbylene group, optionally substituted with up to 5 heteroatoms selected from the group consisting of O, N and S;
each E independently represents a C₁-C₁₈ hydrocarbylene group, optionally substituted with up to 5 heteroatoms selected from the group consisting of O, N and S;
each m independently represents an integer from 5 to 1000, inclusive; and
n represents an integer greater than or equal to two.

6. The chain-extended silicone polyaziridine of claim 5, wherein each R¹ independently represents H, C₁-C₁₂ alkyl, C₂-C₁₂ alkenyl, C₂-C₁₂ alkynyl, phenyl, C₇-C₁₅ alkaryl, C₇-C₁₅ aralkyl or C₃-C₁₂ cycloalkyl.

7. The chain-extended silicone polyaziridine of claim 5, wherein each R² independently represents H, methyl, or phenyl.

8. The chain-extended silicone polyaziridine of claim 5, wherein each R³ independently represents methyl or ethyl.

9. The chain-extended silicone polyaziridine of claim 5, wherein each A represents a C₁-C₆ alkylene group.

10. The chain-extended silicone polyaziridine of claim 5, wherein each E represents a C₁-C₆ alkylene group.

11. The chain-extended silicone polyaziridine of claim 5, wherein each m independently represents an integer from 5 to 100, inclusive.

12. The chain-extended silicone polyaziridine of claim 5, wherein n represents an integer from 1 to 5, inclusive.

13. A curable composition comprising:
a chain-extended silicone polyaziridine according to claim 5; and
a curative for the chain-extended silicone polyaziridine.

14. The curable composition of claim 13, further comprising at least 30 percent by volume of thermal filler based on total volume of the curable composition.

15. A thermal gap filler comprising:
an at least partially cured reaction product of the curable composition of claim 14; and
at least 30 volume percent, based on total volume of the thermal gap filler, of thermal filler, wherein the thermal gap filler has a thermal conductivity of at least 0.5 watt per meter-kelvin.
